(19) United States
(12) Patent Application Publication
(10) Pub. No.: US 2013/0057863 A1
(43) Pub. Date: Mar. 7, 2013

(54) NANOPOROUS OPTICAL SENSOR ELEMENT

(71) Applicants: Mads Bøkner Christiansen, Hillerod (DK); Sokol Ndoni, Rodovre (DK); Martin Etchells Vigild, Farum (DK); Anders Kristensen, Copenhagen O (DK); Peter Thomsen, Kgs. Lyngby (DK)

(72) Inventors: Mads Bøkner Christiansen, Hillerod (DK); Sokol Ndoni, Rodovre (DK); Martin Etchells Vigild, Farum (DK); Anders Kristensen, Copenhagen O (DK); Peter Thomsen, Kgs. Lyngby (DK)

(73) Assignees: BIOMODICS APS, Kgs. Lyngby (DK); Danmarks Tekniske Universitet, Lyngby (DK)

(21) Appl. No.: 13/577,736

(22) PCT Filed: Feb. 15, 2011
(86) PCT No.: PCT/DK11/50044

§ 371 Date: Nov. 19, 2012

Related U.S. Application Data
(60) Provisional application No. 61/304,573, filed on Feb. 15, 2010.

(30) Foreign Application Priority Data
Feb. 15, 2010 (EP) 10153600.1

(51) Int. Cl. G02B 6/00; G01N 21/25; B23P 17/04; G01J 1/04

(52) U.S. Cl. 356/409; 250/227.14; 385/12; 29/428

(57) ABSTRACT

A sensor element is disclosed. The sensor element comprises a first element which is nanoporous, and a second element which is nanoporous, the second element enclosing the first element. The surfaces of the nanopores of the first- and second element differ in hydrophilicity, so that the surfaces of the nanopores of one element is generally more hydrophobic while the other is generally more hydrophilic, and hence the sensor element is capable of selectively having the first element filled with a fluid. The sensor element is capable of guiding light through the fluid-filled first element and can act as a nanoporous waveguide. The sensor element according to the invention is particularly useful for spectroscopy on fluids.

### FIELD OF THE INVENTION

The present invention relates to a sensor element and in particular to a nanoporous sensor element.

### BACKGROUND OF THE INVENTION

A number of optical techniques, such as spectroscopy, are utilized for measurements on fluids, where light is transmitted through the fluid along an optical path. For numerous applications the information gained about substances comprised in a fluid by using optical techniques is highly useful. However, many fluids comprise opaque particles which are detrimental for the use of optical techniques, since these particles scatter or absorb light. This entails a risk of misleading results or even a risk that the measurements are rendered unfeasible. The analysis of fluids with opaque particles often necessitates that these opaque particles are kept away from the optical path. A common method of doing this involves centrifugation of the sample prior to analysis and subsequent extraction of a clear portion of the fluid where the opaque particles are present in tolerable, low concentrations, albeit this procedure is tedious as it involves the step of centrifugation.

Another common method of removing opaque particles involves filters, such as nanoporous materials, which are used to filter the solution to be analyzed. An example of this is given in the internationally published patent application WO 2008/058084 A2 which discloses an analyte sensor for Optical Coherence Tomography (OCT), wherein nanopores associated with a sensor body element permits the diffusion of the analyte into the sensor body element while keeping red blood cells out. Optical energy transmitted through the sensor body element provides for an optical measurement of the analyte.

Methods of fabrication of nanoporous elements are generally known in the art and can be found in the literature, such as in the patent application WO 2008/058084 A2.

### SUMMARY OF THE INVENTION

It would be advantageous to achieve a sensor element which achieves at least one of the following characteristics: High transmission of light, relatively stable transmission with respect to a length of the optical path, relatively stable transmission with respect to a curvature of the optical path. In general, the invention preferably seeks to mitigate, alleviate or eliminate one or more of the above mentioned disadvantages singly or in any combination. In particular, it may be seen as an object of the present invention to provide a solution to the above mentioned problems, or other problems, of the prior art.

To better address one or more concerns, in a first aspect of the invention, there is presented a sensor element comprising:
a first element having a first end, adapted to receive light and a second end adapted to output or reflect light, the first element being extended along a direction of propagation, at least part of the first element being nanoporous, and
a second element being nanoporous, the second element being placed adjacent to at least a part of the first element along the direction of propagation, and
an access to at least a part of the first element for a fluid, so that the first element may in a situation of use be filled by a fluid,

wherein surfaces of the nanopores of the first element and the second element differ in hydrophilicity, so that one of the first element and the second element is generally hydrophilic and the other of the first element and the second element is generally hydrophobic.

The inventors of the present invention have realized that while a nanoporous first element is advantageous for the filtration fluids in order to keep certain particles out of the first element, the transmission of light through the first element is not necessarily optimal as the evanescent optical field of the guided mode may be attenuated if it extends into the surrounding medium, such as into an opaque fluid.

By ‘being placed adjacent to’ is understood, that the second element is placed adjacent to the first, so that an evanescent optical field of the guided mode from the first element may enter the second element. It is understood, that the second element may enclose only a part of the first element. In case the second element encloses only a part of the first element, a third element, such as a solid element being placed adjacent to the remaining part, may ensure that the surrounding media cannot enter a volume adjacent the first element where the evanescent optical field of the guided mode of the first element may be present. In one particular example, the first element is a part of a planar element, where the first element extends from the top side to the bottom side of the planar element, and the second element is another part of the planar element, where the second element is placed on one or both sides of the first element, and extending from the top side to the bottom side of the planar element, and a third element may be placed adjacent to the top and bottom side of the planar element.

In a particular embodiment, there is provided a sensor element wherein the second element is enclosing at least a part of the first element along the direction of propagation. The second element encloses, such as fully encloses, the first element around the optical axis of the first element, such as the second element enclosing the first element 360 degrees around the optical axis of the first element.

Enclosing the first element in a second element with a low, well-defined refractive index enables the fluid filled first element and the second element to act as a waveguide. The optical path through the waveguide can be relatively long, and hence a long interaction length is obtained while the transmission can be kept high. The long interaction length and high transmission enables more interactions between light and analytes and a high intensity of the transmitted light. As a consequence measurements may be faster, more precise, more sensitive, and/or more reliable.

Reference is made to ‘hydrophobic’ and ‘hydrophilic’, the terms are to be interpreted as is generally understood in the art. In general, a ‘hydrophilic surface’ is understood to be a surface upon which a droplet of fluid has a contact angle below 90°, while a droplet on a ‘hydrophobic surface’ has a contact angle above 90°. The contact angle, and hence the hydrophilicity, determines if it is favourable for the fluid to enter the nanoporous channels, since it determines if the meniscus is convex or concave. By contact angle is understood the static contact angle.

The term ‘hydrophilicity’ is used as a quantitative property, indicating how hydrophilic or hydrophobic a surface is. Specifically, when referring to ‘hydrophilicity’ of a surface, it is understood that a droplet of fluid on the surface can have any contact angle, including a contact angle corresponding to a hydrophilic or hydrophobic surface, i.e., a surface associated with a degree of hydrophilicity can be hydrophilic or hydrophobic.

Light is understood to be electromagnetic radiation having a wavelength in an interval, such as electromagnetic radiation having wavelengths in the broad interval ranging from the wavelength of near ultraviolet light to the wavelength of infrared light. It is noted that the light might be in an interval which is broad or narrow, such as representing a single wavelength, such as monochromatic light. When referring to wavelength, the wavelength is understood to be the wavelength of light in free space.

The fluid may access the first element through the sides of the first element, e.g., via through-going holes in the second element, or through the first end or the second end of the first element, which are protruding from the enclosing second element.

The sensor element according to the invention is advantageous in that it integrates several functions into a single sensor element. The first element can be filled with a fluid simply by bringing at least a part of the first element into contact with said fluid, since capillary forces can fill the nanopores of the first element, even overcoming gravitational forces. Furthermore, the nanopores themselves may serve as a filter, capable of hindering the entry into the first element of particles which are detrimental for the transmission of light through the first element.

Light may enter into the first element via the first end of the first element, traverse the first element and exit the first element at the second end of the first element. Alternatively, the light may also exit the first element from the first end if the second end is enabled to reflect light internally. In the latter case, a possible sequence of events is: Initially the light enters into the first element via the first end, subsequently the light travels through the first element and reaches the second end of the first element where the light is reflected, finally the light travels back through the first element and exits through the first end where it can be detected. An advantage of reflecting the light at the second end may be that the light then traverses the first element twice, effectively doubling the interaction length. Another advantage may be that a light source and a detector, for respectively generating and detecting light, can be kept at the same end.

In some embodiments the sensor element has blunt ends. In other embodiments, the sensor element has at least one sharp-pointed end, such as an end capable of penetrating a relatively soft barrier, such as an end capable of penetrating skin. An advantage of having a sharp-pointed end might be that the sensor element may thus be capable of acting as a needle, such as a syringe needle. This could be advantageous for taking samples of fluids, such as body fluids.

In another embodiment of the invention, there is presented a sensor element, wherein the first element is arranged to be part of a core of an optical waveguide, when the nanopores of the first element are filled by the fluid.

Thus, in addition to the functions described above, the sensor element may also form a waveguide. The volume enclosed by the first element can have an effective refractive index which is relatively high once the nanopores of the first element are filled with a fluid of a high refractive index. Since the first element is enclosed by the second element, which is also nanoporous, with empty nanopores due to the hydrophilicity of the surfaces of the nanopores, the sensor element may act as a waveguide, guiding light through the fluid-filled first element. As opaque particles may be kept out of the first element, a relatively long transparent fluid filled waveguide may be obtained, and hence the sensor element is advantageous for optical spectroscopy. An advantage of forming an optical waveguide according to the invention may be that the optical path through the waveguide, and hence through the fluid filled first element, is relatively long. A long optical path may yield a long interaction length, and this in turn may yield improved spectroscopic measurements. Alternatively, the spectroscopic measurements may be conducted faster due to the longer interaction length.

Still further, an advantage of the present embodiment may be that bubbles of air are not likely to obstruct measurements by getting into the first element and obstruct the transmission of light through the first element. Bubbles may obstruct transmission of light due to their inherent gas-fluid interface.

The first element might be dimensioned so as to form the core of a single mode optical waveguide or the core of a multi mode optical waveguide, when the nanopores are filled with a fluid. In yet another embodiment of the invention there is presented a sensor element, wherein the first element is dimensioned so as to form the core of a single mode optical waveguide, when the nanopores are filled with a fluid.

An advantage of making a single mode waveguide available is that if the waveguide is single mode, the light in it has only one effective refractive index. This means that, e.g., a grating defined in the waveguide reflects one wavelength only, which is easier to track.

In a further embodiment a sensor element is presented, wherein the first element and/or the second element comprises a polymeric material.

In particular, polymeric materials comprised by the first element and/or the second element may include diblock copolymers, such as 1,2-polybutadiene-Polydimethylsiloxane (1,2PB-PDMS) or polystyrene-Polydimethylsiloxane (PS-PDMS) where the PDMS block has been selectively removed.

In another embodiment, a sensor element is presented, wherein the first element and/or the second element comprises a crystal structure. In a specific embodiment, the first element and/or the second element may comprise a crystal structure where nanoporous material is comprised within the interstitial volume of the crystal structure.

In a still further embodiment a sensor element is presented, wherein the first and/or second element comprises a polymer matrix which has a porosity of 0.1-90% % (v/v) and an initial water absorption (% (w/w)) so that the ratio between said initial water absorption (% (w/w)) and said porosity (% (v/v)) is at the most 0.05, said matrix at least in part capable of being rendered more hydrophilic so that said part of said polymer matrix has a final water absorption (% (w/w)) so that the ratio between said final water absorption (% (w/w)) and said porosity (% (v/v)) is at least 0.05.

For polar fluids, such as water, capillary forces will tend to fill a nanopore with hydrophilic surfaces. Hence, for applications directed to polar fluids, it is favourable that the first element has nanopores with hydrophilic surfaces while the second element has nanopores with hydrophobic surfaces. It is noted however, that for applications with fluids which are non-polar, it may be favourable to reverse the relationship between the hydrophilicity of the surfaces of the nanopores of the first- and second element, or it may be favourable to render the surfaces in yet another manner. For example, for an application directed towards a fat-based solution, it is favourable to render the surfaces of the nanopores of the first element lipophilic, and the surfaces of the nanopores of the second element lipophobic. By a ‘lipophilic’ surface is generally understood a surface which is also hydrophobic, and by a ‘lipophobic’ surface is generally understood a surface which is also hydrophilic.

In another embodiment a sensor element is presented, wherein the bulk material of the first element is similar to the bulk material of the second element.

An advantage of this is that the first element and the second element may initially be constructed from substantially the same material. In order to provide the difference in hydrophilicity of the surfaces of the nanopores of the first element and the second element, only the surfaces need to be modified.

In yet another embodiment a sensor element is presented, wherein the nanopores of the first and/or second element comprise branched nanopores.

By ‘branched nanopores’ is understood nanopores, which ramify, i.e., individual nanopore channels can be connected, so that a fluid can pass from one nanopore to another nanopore. Individual nanopores which intersect each other are also understood to be branched nanopores. Since a plurality of nanoporous channels are given by the branched nanopores, a nanoporous network is present. An advantage of this is that a nanoporous network comprising branched polymers allows a fluid entering into one nanopore to subsequently enter into another nanopore. An effect of this may be that even if only a small section of the first element comes into contact with a fluid, the fluid may still fill substantially all of the nanopores of the first element, as the fluid can go from one nanopore to another nanopore and so forth.

In an embodiment a sensor element is presented, wherein an effective average diameter of nanopores of the first element and/or the second element is similar to or inferior to a wavelength, lambda, of light transmitted through the sensor element.

The effective diameter of a nanopore, Dₙₐₙₒₚₒᵣₑ, may be defined as

$${D}_{nanopore} = \sqrt{4 \frac{{A}_{nanopore}}{π}}$$

where Aₙₐₙₒₚₒᵣₑ is the area of the cross-section of the nanopore in a plane orthogonal to an axis in a lengthwise direction through the nanopore.

If this relationship between lambda and Dₙₐₙₒₚₒᵣₑ as outlined above is satisfied, light of wavelength lambda travelling in the inhomogeneous mixture of the material of the first- or second element and the medium present in the nanopores of that element, behaves as if the light were travelling in a homogeneous medium having an effective refractive index which is calculated from the refractive indices of the first- or second element material and the medium comprised within the nanopores of that element, respectively. In a first approximation, the effective refractive index is given as a weighted average between the two refractive indices of the element medium and the medium located within the nanopores. A possible consequence of this is that the effective refractive index of the volume enclosed by any of the first- or second element is affected by the refractive index of the medium present in the nanopores of that element. In particular, the effective refractive index of the volume enclosed by the first element can by increased by filling its nanopores with a medium with a relatively high refractive index.

In another embodiment, a sensor element is presented, wherein an effective average diameter of nanopores of the first element and/or the second element is similar to or inferior to a reduced wavelength, lambdaᵣ, of light transmitted through the sensor element, where the reduced wavelength, lambdaᵣ, refers to the wavelength of the light propagating through the first element. Such embodiment is particularly advantageous for applications where the effective refractive index of the volume enclosed by the first element is relatively high compared to the wavelength in free space, and where the reduced wavelength, lambdaᵣ, as a consequence is relatively small compared to the free space wavelength, lambda. In such applications, this is advantageous since light propagating through the first element behaves as if the light were travelling in a homogeneous medium having an effective refractive index which is calculated from the refractive indices of the first- or second element material and the medium comprised within the nanopores of that element, respectively.

In yet another embodiment a sensor element is presented, wherein a path length L through the part of the first element which is enclosed by the second element, along a direction of propagation through the first element, exceeds an effective diameter of the first element of a cross section, the cross-section being in a plane orthogonal to the direction of the optical path.

The effective diameter, D_element1, may be defined as

$${D}_{element 1} = \sqrt{4 \frac{{A}_{element 1}}{π}}$$

where A_element1 is the area of the cross-section of the first element in a plane orthogonal to an optical path through the first element.

In yet another embodiment a sensor element is presented, wherein the first element has a curved portion so that a straight line, which intersects the first end of the first element and the second end of the first element, has a portion between the first end of the first element and the second end of the first element which does not lie within the first element.

An advantage of this may be that it can easily be detected whether the first element is filled with a transparent fluid with a relatively high refractive index. If this is not the case, the sensor element may not show waveguiding properties, and thus no light is transmitted from the first end of the first element to the second end of the first element. In other words, if the first element is not filled with the fluid to be spectroscopically analyzed, then there is not transmitted light through the first element which could otherwise have been detected and erroneously interpreted as measurement data.

In a further embodiment a sensor element is presented comprising a plurality of first elements.

An advantage of having a plurality of first elements is that multiple first elements can be filled with one or more fluids to be analyzed. This enables the user to rapidly and easily get more measurement data for either different fluids or multiple measurements for one fluid.

Such plurality of first elements might include a plurality of similar first elements. Such plurality of similar elements may be beneficial, since this facilitates a plurality of similar measurements. However, the plurality of first elements might also include one or more first elements which differ from the other first elements. Such inclusion of different first elements within the plurality of first elements may be beneficial in order to measure different parameters and/or to obtain reference measurements. In one particular example, one or more first elements are equipped with one or more optical components, e.g., a diffraction grating may be defined in the waveguide, reflecting a narrow interval of wavelengths, whereas one or more other first elements are not. Particularly, the plurality of first elements may comprise at least two first elements each having a diffraction grating, which are arranged so that the narrow interval of wavelengths reflected differs for the at least two diffraction gratings. An advantage of this may be that probing of a fluid within the first elements is facilitated for different wavelengths. Furthermore, a first element within the plurality of first elements might not be equipped with a grating. In another particular example, the sensor device also comprises an optical waveguide including a core which is not nanoporous, such as comprising solid material. Such optical waveguide, including a core which is not nanoporous, could enable valuable reference measurements.

In another embodiment a sensor element is presented, wherein the first end of the first element end and/or the second end of the first element is adapted to be separated from the first element, thereby forming a new first end of the first element and/or a new second end of the first element on the remaining part of the first element.

An advantage of this may be, that in cases where an end of the first element becomes non-transparent, such as the end being covered or filled by opaque particles, separating such non-transparent end from the first element is likely to bring along the removal of the non-transparent portion of the first element, such as the opaque particles covering or filling the non-transparent end, and hence create a transparent new end of the remaining part of the first element. In other words, if an end of the first element is covered or filled with opaque particles and hence non-transparent, the transparency in/out of the first element can be regained by simply removing that end, such as breaking of that end, such as cutting of that end, such as grinding that end.

In yet another embodiment a system is presented, which comprises a sensor element according to any of the previous claims, the system further including a light source and/or a light detector.

By further including a light source, a user of the system is enabled to generate light which can be input into the first element via the first end, as the first element is adapted to receive light of wavelength lambda. By further including a light detector the user is enabled to detect light which has been output from the second end of the first element. Alternatively, the light may be output from the first end, as the second end may be enabled to reflect light as described above.

In accordance with a second aspect of the invention, the invention relates to use of a sensor element or system according to any of the first or second aspect of the invention for spectroscopy on a fluid.

In accordance with a third aspect of the invention, there is presented a method of manufacturing a sensor element according to the first aspect of the invention, the method comprising the steps of
providing a first element with nanopores, and
providing a second element enclosing at least a part of the first element around an axis through the first element, and
providing an access to at least a part of the first element for a fluid, so that the first element may in a situation of use be filled by a fluid, and
modifying the hydrophilicity of the surfaces of the nanopores of the first element and/or the second element, so that the surfaces of the nanopores of the first element and the second element differ in hydrophilicity, so that one of the first element and the second element is generally hydrophilic and the other of the first element and the second element is generally hydrophobic.

It is understood that the first element and second element may initially be monolithically integrated, so that the act of providing a first element with nanopores and a second element with nanopores, may be carried out by providing a single monolithic element with nanopores, where a first element different from a second element is formed, e.g., by selectively modifying the surfaces of the nanopores of one element differently with respect to the surfaces of the nanopores of the other element.

In another embodiment, a method is presented wherein the method further comprises the step of drawing the first and/or second element so that the diameter of the first and/or second element decreases and the length increases. An advantage of this is that a plurality of sensor elements can be provided relatively fast and cost-efficiently by separating this elongated first and/or second element into a plurality of first and/or second elements by cutting in plane substantially orthogonal to direction of elongation.

In one other embodiment according to the invention, a method is presented, wherein the step of modifying the hydrophilicity of the surfaces of the nanopores of the first element and/or the second element, includes irradiation with light. In a particular embodiment, this may be controlled photoxidation as in the scientific article by S. Ndoni, L. Li, L. Schulte, P. P. Szewczykowski, T. W. Hansen, F. Guo, R. H. Berg, and M. E. Vigild, “Controlled Photooxidation of Nanoporous Polymers.” Macromolecules 42(12), 3877-3880 (2009) which is hereby incorporated by reference and hereafter referred to as ‘Ndoni2009’.

In a specific embodiment, the light has one or more wavelengths in the ultraviolet range.

In another embodiment according to the invention a method is presented, wherein the irradiation of the first element with electromagnetic radiation occurs prior to providing a second element enclosing at least a part of the first element around an axis through the first element.

According to this specific embodiment a first element is provided and irradiated, before a second element is provided which encloses at least a part of the first element around an axis through the first element. An advantage of this is, that the second element can be kept safely away from the electromagnetic radiation which is irradiated onto the first element, and hence the risk that the electromagnetic radiation affects the second element is eliminated.

In yet another embodiment according to the invention, a method is presented, wherein the first element and/or second element is rotated during irradiation of the first element and/or the second element with electromagnetic radiation.

According to this embodiment, selective irradiation can be obtained by irradiating either the first element or the second element and simultaneously rotating the first element and/or second element. This may be done by using a narrow beam of light which irradiates the first element, the beam of light being orthogonal to a longitudinal axis of the first element and the second element. The light beam is at least partially transmitted through the first- and second element. The diameter of the beam of light is at most as large as the diameter of the first element. By rotating the first element and the second element around the longitudinal axis, light can be permanently incident on at least a portion of the first element, while substantially all portions of the second element is irradiated only periodically and hence only a fraction of the time. Consequently, the light intensity integrated over time is less for the second element compared to the first element. In another example, only the second element is irradiated by a light beam which is tangent to the first element. Rotation of the second element, during irradiation, can enable a homogeneous treatment of the second element.

In yet another embodiment according to the invention, a method is presented, wherein the irradiation with light entails a photochemical reaction involving a multi-photon process.

According to this method, a photochemical reaction is much more likely to be initiated on the surface of the nanopores of either the first element or the second element where a laser pulse, such as a temporally short laser pulse, such as a laser pulse in the femtosecond or nanosecond range, is focused. At the focus point, a multi-photon process may thus be initiated which is not likely elsewhere. For example, if the beam is focused within the first element the reaction is more likely to take place here, even if the beam is transmitted through the second element, since the chance of a multiphoton process taking place depends strongly on the light intensity. At the focus point, a multi-photon process initiates a photochemical reaction which affects the hydrophilicity of the surfaces of the nanopores of the first element.

The first, second and third aspect of the present invention may each be combined with any of the other aspects.

These and other aspects, features and/or advantages of the invention will be apparent from and elucidated with reference to the embodiments described hereinafter.

### BRIEF DESCRIPTION OF THE FIGURES

Embodiments according to the invention will now be described in more detail with regard to the accompanying figures. The figures show one way of implementing the present invention and is not to be construed as being limiting to other possible embodiments falling within the scope of the attached claim set.

FIG. 1 shows end view and side view of an embodiment according to the invention,

FIG. 2 shows a cross-sectional view of another embodiment according to the invention,

FIG. 3 shows an embodiment of the invention with a plurality of first elements,

FIG. 4 shows an embodiment of the invention which includes a light source and a light detector,

FIG. 5 shows one end of an embodiment according to the invention immersed in a beaker with a fluid,

FIG. 6 shows a photograph of an embodiment of the invention where the first element is filled with a clear, transparent portion of an otherwise coloured fluid.

FIG. 7 shows an embodiment of the invention where a first element and a second element is arranged together with a syringe needle,

FIG. 8 shows a nanoporous liquid core waveguide under optical characterization,

FIGS. 9A-B show an example of the filtering capabilities of a nanoporous polymer,

FIGS. 10AB show a first element which is respectively fluid filled and empty,

FIG. 11 shows an exploded view of an exemplary embodiment.

### DETAILED DESCRIPTION OF EMBODIMENTS

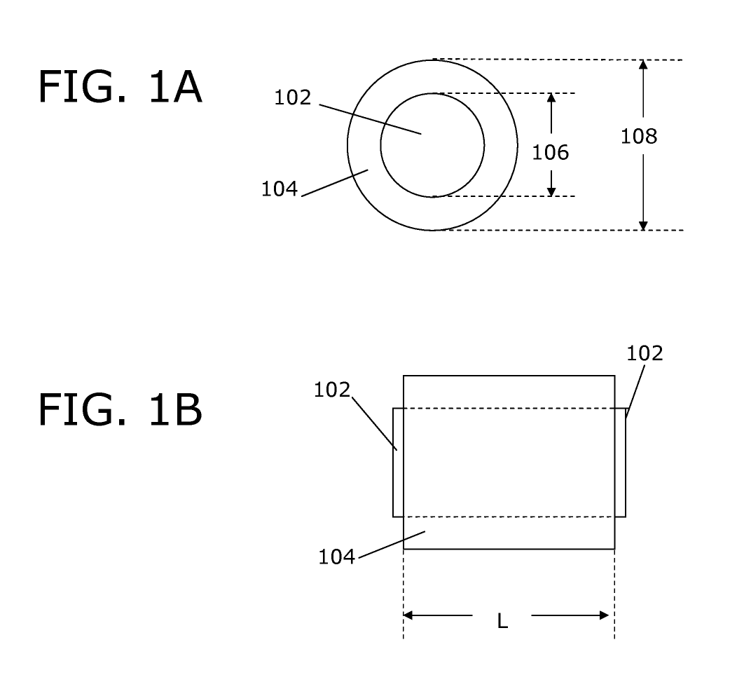

FIG. 1A shows an end view of an embodiment of the invention. In the present embodiment, the first element 102 and the second element 104 both have a substantially circular outer periphery as seen from the end. The first element 102 and the second element 104 are situated concentrically. An outer diameter 106 of the first element is shown, as well as an outer diameter 108 of the second element. In this particular embodiment the first element and second element are straight, co-axial, circular, cylindrical elements. However, in other embodiments the first element and/or the second element may have any shape. In particular, the first- and second element may by straight or curved in any number of ways. Furthermore, the cross-section orthogonal to an optical path through the first- and second element may vary along the length, and have any shape, such as cylindrical, elliptical, rectangular, quadratic and triangular. Notice furthermore, that all illustrations are exemplary embodiments, other relative dimensions than those depicted on the figures are possible.

FIG. 1B shows a side view of the embodiment of the invention also shown in FIG. 1A. The part of the first element which is enclosed within the second element is shown with dotted lines. It can be seen that the first element 102 protrudes from both ends of the second element 104, however, this need not always be the case. In other embodiments, the ends of the first- and second element may be aligned, or one or both ends of the second element may protrude with respect to the respective end of the first element. Although the present embodiment is shown with blunt ends, in other embodiments, the sensor element has at least one sharp-pointed end.

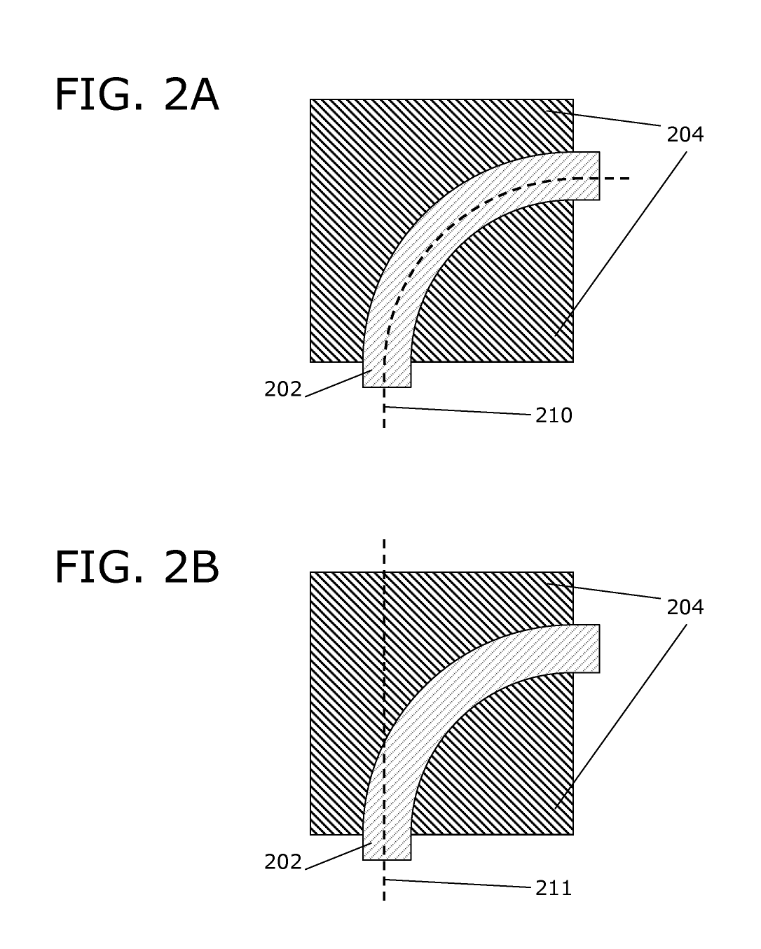

FIG. 2A shows another embodiment of the invention. In the figure, a cross-section is shown. The first element 202 is enclosed by the second element 204. An axis 210 of the first element is shown, and it is apparent that the first element 202 has a curved portion, so that its axis does not form a straight line. Furthermore, in the present embodiment, a straight line through the first element, from one end to the other, would intersect the second element. Thus, light travelling through the first element, the light initially having a direction along one end of the axis, only arrives at the other end of the first element if the first element is capable of guiding light. If the first element is not capable of guiding light, the light can escape from the first element, and hence not reach the second end of the first element, as illustrated in FIG. 2B. For example, if the first element 202 and the second element 204 have substantially the same optical properties in dry conditions, the first element cannot act as a waveguide for light in such conditions. However, if the first element is nanoporous and capable of having its nanopores filled with a fluid with a higher refractive index, then the first element may be capable of guiding light once filled with fluid. It is noted, that the waveguide may be equipped with one or more optical components, e.g., a diffraction grating may be defined in the waveguide, reflecting a narrow interval of wavelengths.

FIG. 2B shows an embodiment which is similar to the embodiment shown in FIG. 2A. However, in the present figure the embodiment is shown in dry conditions, where the optical properties of the first element 202 is substantially similar to the optical properties of the second element 204, and in particular the refractive indices of the first- and second elements are substantially similar. In this case, light is not guided along the first element 202, but instead capable of traversing the interface between the first and second elements, even at glancing angle, and hence capable of escaping the first element and follow a straight line as illustrated by the dotted line 211.

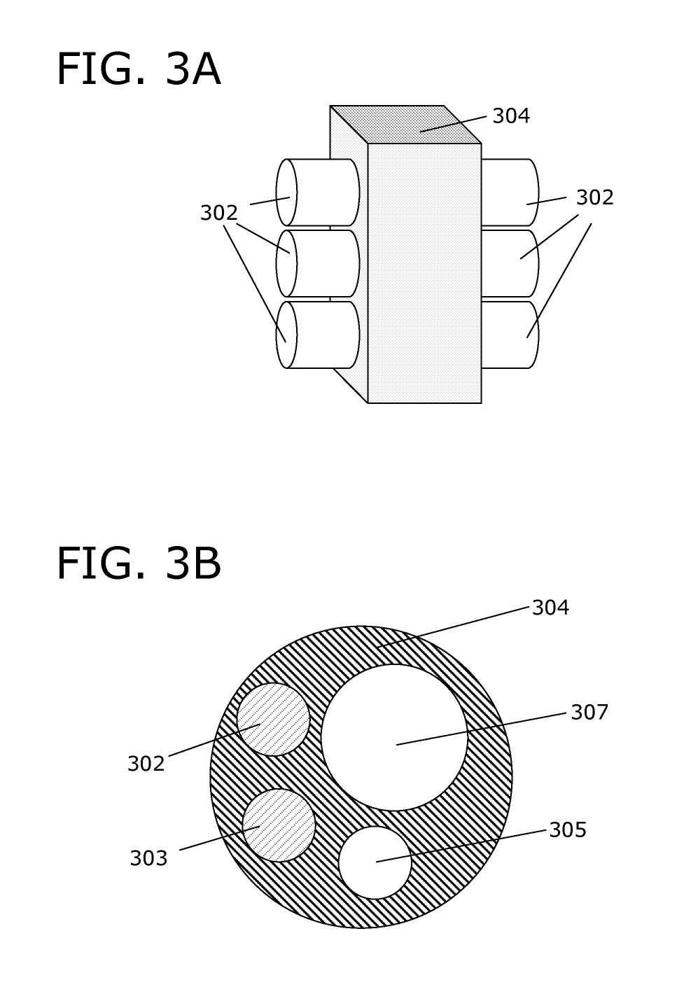

FIG. 3A shows another embodiment of the invention, the embodiment comprising a plurality of first elements 302. In this particular embodiment, three parallel, straight first elements are present, each first element being enclosed by a second element 304. Alternatively, any other number of first elements could be present, and the first elements are not limited to be neither straight nor parallel. In the present embodiment, both ends of each of the first elements 302 protrude from the second element 304.

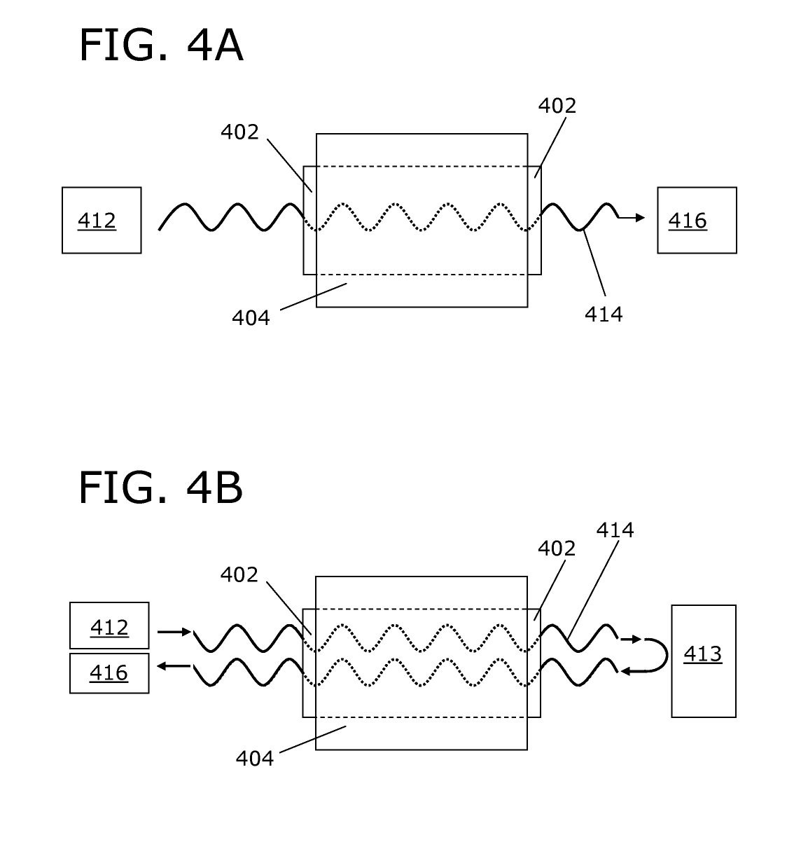

FIG. 3B shows yet another embodiment of the invention. In this particular embodiment a cross section of an elongated second element 304 is seen, comprising a first element 302 and another first element 303. Furthermore, a first hollow passage 305 is depicted, the passage 305 also capable of guiding light. A second hollow passage 307 is shown. The elongated second element 304 may form part of a needle, such as a needle for penetrating skin, such as a needle for taking samples of blood, or other body fluids, from animals or humans. In use, such needle may penetrate the skin and draw a volume of blood through the passage 307, while also enabling optical measurements of the fluid filled into the first elements 302, 303 and the hollow passageway 305. Measurements on the fluid comprised within the volumes in first elements 302, 303 or hollow passage 307 may be carried out using the scheme outlined in FIG. 4B.

FIG. 4A shows yet another embodiment of the invention which, besides a first element 402 enclosed by a second embodiment 404, also comprises a light source 412 and a light detector 416. The figure furthermore shows light 414 travelling in a direction through the first element 402 and the second element 404 from the light source 412 towards the light detector 416. The light detector may also be equipped with means for spectrally resolving light, so as to be able to output spectroscopic data.

FIG. 4B shows an alternative embodiment, a reflective element, such as a mirror 413, is provided at the second end of the first element, so that the light 414 can be reflected back in a direction along the optical path towards the first end where it can exit the first element. In such embodiment, the light source 412 and the detector 416 can both be placed at the first end.

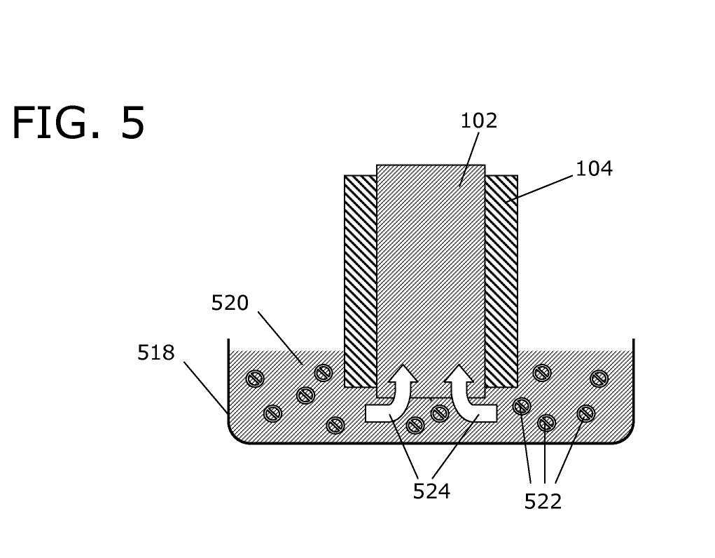

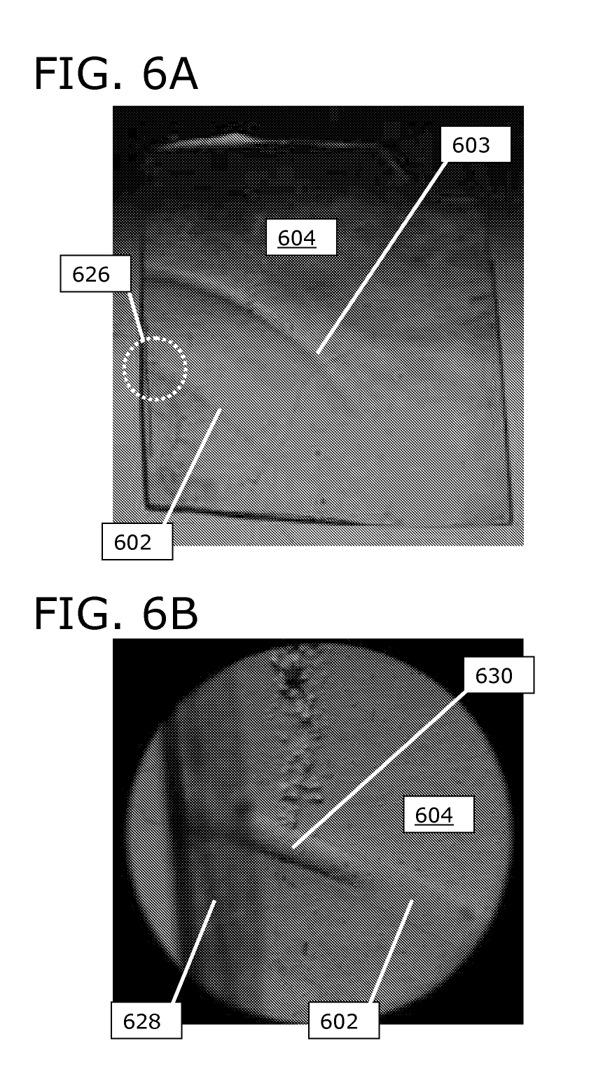

FIG. 5 shows a cross-section of the embodiment also depicted in FIGS. 1A-1C. In the present figure, one end of the first element 102 and second element 104 is immersed in a beaker 518 with a water-based fluid 520. The fluid 520 in the beaker is the fluid which is subject to spectroscopic analysis. However, opaque particles 522 hinder transmission of light directly through the fluid. The opaque particles 522 may scatter or absorb light. Immersion of the nanoporous elements 102, 104 allows the fluid to fill the nanopores of the first element 102, as the nanopores of the first element in the present embodiment have hydrophilic surfaces. On the other hand, the second element 104 is not filled with fluid, as the nanopores of the second element have hydrophobic surfaces. The arrows 524 show a direction of the fluid into the first element 102 during filling of the first element. Capillary forces aid in filling the first element 102 with fluid 520, and it is noted that capillary forces are capable of overcoming gravitational forces. Furthermore, the size of the nanopores endows them with a filtering effect, capable of blocking the entry into the first element 102 for the opaque particles 522. Thus, the first element 102 is filled with the fluid 520 but the opaque particles are left out, so that a spectroscopic analysis is facilitated in that light transmitted through the first element will not be blocked by the opaque particles 522. The fluid could be a large number of fluids. For example, the fluid could be blood where the non-transparent particles are red blood cells. Alternatively, the fluid could be milk with non-transparent particles in the form of globules of fat. FIG. 6A shows a photograph of first elements 602, 603 which are nanoporous. Furthermore, a second element 604 is shown. The dotted circle 626 indicates the part of the first element 602 and the second element 604 which are shown enlarged in FIG. 6B.

FIG. 6B shows first element 602 and a second element 604. In the figure, a coloured fluid 628 has been applied to an end of the first element 602, and the first element is seen to be partially filled with a clear, transparent portion 630 of the otherwise coloured fluid.

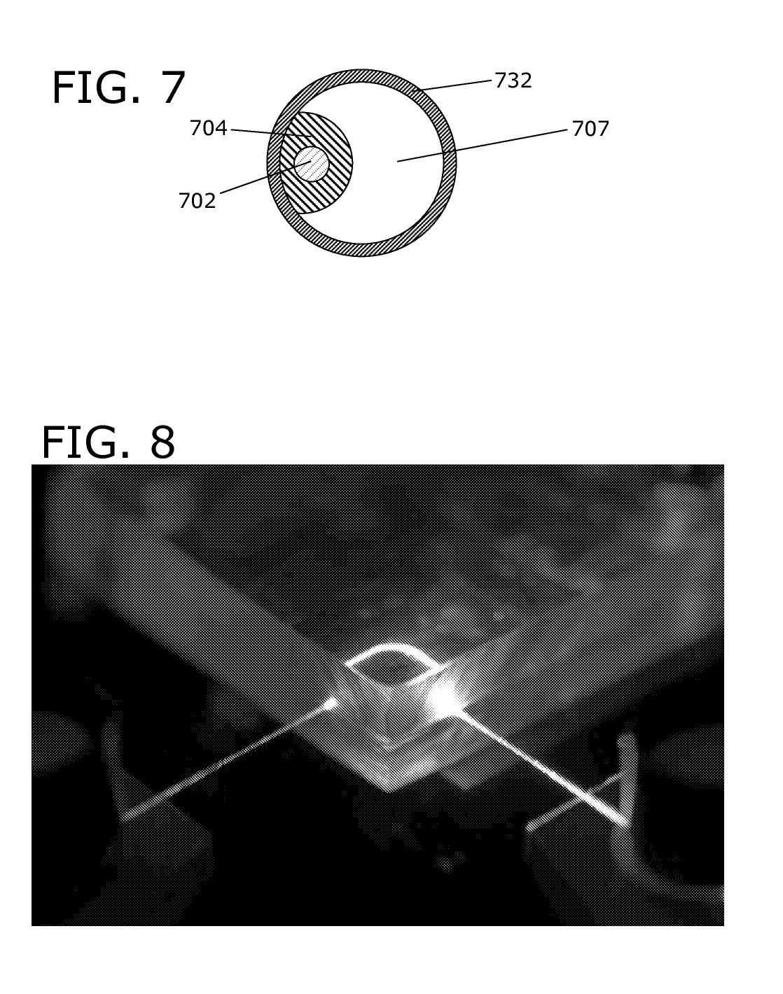

FIG. 7 shows another embodiment of the invention, where a cross section of a syringe needle 732 is shown. The syringe needle is equipped with a first element 702 and a second element 704 so that measurements on a fluid filled into first element 702 can be carried out. This allows for measurements while using the syringe needle, such as using the needle for taking a sample of body fluid through passage 707, or using the needle for applying a fluid through passage 707, such as a dose of medicine or anaesthetics. In this particular example, the first element 702 and second element 704 are on the inside of the syringe needle 732, but it could also be on the outside.

In the following, the materials and methods for fabricating a waveguide according to an embodiment of the invention are given.

Polymer Synthesis

The 1,2-polybutadiene-b-polydimethylsiloxane (PB-b-PDMS) diblock copolymer precursor was synthesized by sequential living anionic polymerization in tetrahydrofuran (THF). sec-Butyllithium was used as initiator. The polymerization of 1,3-butadiene was performed at −20±3° C. for 3 hours. Then hexamethylcyclotrisiloxane, D₃, was added to the reactor, and the temperature was raised up to 0° C. The polymerization of D₃ took 3 days before termination with chlorotrimethylsilane. The synthesis is also described in a scientific article by Guo, F.; Andreasen, J. W.; Vigild, M. E.; Ndoni, S. Macromolecules 2007, 40, 3669-3675, which is hereby incorporated by reference.

Polymer Casting and Etching

Nanoporous polymer is derived from the anionically synthesized PB-b-PDMS di-block copolymer as described in the scientific article by Ndoni, S.; Vigild, M. E.; Berg, R. H. J. Am. Chem. Soc. 2003, 125, 13366-67, which is hereby incorporated by reference. The copolymer solution is prepared in THF (Sigma Aldrich) with dicumyl peroxide (DCP) (Sigma Aldrich) which acts as a thermal cross-linking agent. Upon adequate mixing, the solution is spread over a single side polish silicon wafer. The silicon wafer is coated with low surface energy fluorinated organosilane molecule using Molecular deposition (MVD). The silicon wafer is subjected to vacuum drying for 7 hours in order to ensure complete drying of polymer from THF. The block copolymer mixed with DCP is sandwiched by placing another MVD coated silicon wafer with 100 micron steel spacers in between to control the resulting polymer film thickness. The sandwich is further pressed under vacuum in a compression press for 30 minutes. In the next step, the silicon wafer sandwich is sealed in a steel cylinder filled with nitrogen and heated in an oven at 140° C. for 100 minutes to carry out cross-linking of the majority block polybutadiene. At this temperature, the di-block copolymer self assembles into a gyriod morphology which is captured by the cross-linking reaction. Inert atmosphere in cross-linking cylinder is desired to avoid thermal oxidation of the polymer from oxygen radicals. Cross-linked polymer is subjected to chemical etching of the PDMS block using Tetrabutylammonium fluoride (Sigma Aldrich, 1M) in THF for 5 hours. The film is further washed sequentially in THF and methanol and dried in vacuum.

UV Hydrophilization

The surface can by hydrophilized by grafting a thiol with one or more hydrophilic groups on the inner pore surface. In principle any thiol can be used, but Mercaptosuccinic acid (MSA) (Sigma Aldrich) has primarily been used. MSA with two terminal carboxylic groups is a hydrophilic molecule along with a thiol group.

As photoinitiator 2, 2-Dimethoxy-2-phenylacetophenone (DMPA) (Sigma Aldrich) has been used. Thiol solution is prepared in ethanol with 500 mM concentration of MSA and 10 mM DMPA. Ethanol is a good solvent for MSA and DMPA and it also fills into the nanopores. Due care is taken to prevent any light exposure of the thiol solution. The nanoporous polymer is immersed in thiol solution for 30 minutes to facilitate loading of the solution. The thiol loaded polymer is aligned with a photolithographic mask and placed in a dedicated chamber to carry out photochemistry. A flood exposure collimated source 1000 W Hg(Xe) (Newport) at I-line (5.2±0.1 mW/cm²) is used for the thiol-ene grafting.

An oxidized black aluminum chuck is used to hold lithography mask. This will ensure absorption of UV light passing through the polymer film by an antireflecting surface. This avoids an over exposure of the unexpected region under the mask from the rear side. The reaction is carried out at 22±1° C. in a cleanroom.

UV light at 365 nm excites DMPA generating radicals which triggers thiol radical formation. The thiol radicals selectively attacks the pendant double bond in 1,2-polybutadiene polymer available at the inner pore surfaces. Upon grafting MSA onto the pore wall, opened double bond results in generation of another thiol radical by hydrogen abstraction mechanism. The process is thus step growth and it is quantitative. The reaction is also insensitive to oxygen presence which makes the reaction conditions less stringent. The reaction is carried out for the duration of typically 30 minutes. During the course of reaction, the polymer is in constant contact with an excess of thiol solution. This prevents crystallization of MSA and DMPA in the pore volume. Same MSA and DMPA concentration is maintained in the excess solution to prevent possible concentration driven transport of chemicals out of nanopores.

After exposure, the polymer is removed from the mask and subjected to washing. The exposed polymer sample is ultrasonicated in pure ethanol for 1 h. This process is carried out in the cleanroom or in a dark room outside with due safety measures to avoid any polymer-light contact. It is further washed in fresh ethanol for 1 hour more followed by final THF sonication for 30 minutes.

Optical Measurements

Measurements are performed on 100 micrometer thick planar waveguide chips. The waveguides typically have a width of 100-500 μm, and consist of two straight segments of length 0-15 mm connected by a 90° turn with a radius of curvature of 3 mm.

Two solid state upper and lower claddings are used: Unmodified and thus hydrophilic nanoporous polymer or fluorinated ethylene propylene (FEP). The cladding layers (corresponding to third element 1134, 1136 in FIG. 11) are positioned on top and bottom of the chip and the entire assembly is clamped between two blocks of polystyrene (PS). Alternatively the cladding can be formed by the fluid under investigation, e.g. water, by positioning polymer spacers between the waveguide and the PS holder parts.

For the solid state claddings the waveguides are filled by subjecting the end of the waveguides to the fluid under investigation or submerging the entire holder including the waveguide and claddings.

To perform measurements, an optical fiber transmitting light is positioned very close to one end of the waveguide and the output is collected from the other end of the waveguide with a second fiber. Typically the core diameter of the input waveguide is 62.5 μm, while the output guide has a core diameter of 400 μm. A PS holder with a waveguide mounted between FEP sheets is shown in FIG. 8, along with the input and output fibers.

FIG. 8 shows a nanoporous liquid core waveguide under optical characterization. The waveguide chip is clamped in a holder between sheets of the cladding material. Light is coupled from an optical fiber into one end and collected with another fiber from the other end.

The light used is laser light from HeNe (633 nm, red) or Nd:YAG (532 nm, green) lasers. The laser beam is split by a beamsplitter and one of the beams is monitored with a photo diode powermeter, while the other beam is launched in the input fiber using a microscope objective. The output fiber can either be connected to a second photodiode to measure the propagation and/or absorption loss in the waveguide or a spectrometer to detect fluorescence in the investigated fluid.

Results can be seen in Tables I-II in Annex 1, for respectively water as cladding (where ‘cladding’ is understood to third element 1134, 1136 as depicted in FIG. 11), FEP sheets, and nanoporous polymer of the same type as is used as second element. The loss is calculated according to the formula: loss=−10*log₁₀(ratio). The loss per length is given by linear regression of the loss as a function of length, and the loss per length is respectively given as the slope of the regression resulting in (cladding type in parentheses) 0.71 dB/mm (water), 0.68 dB/mm (FEP) and 0.55 dB/mm (nanoporous polymer).

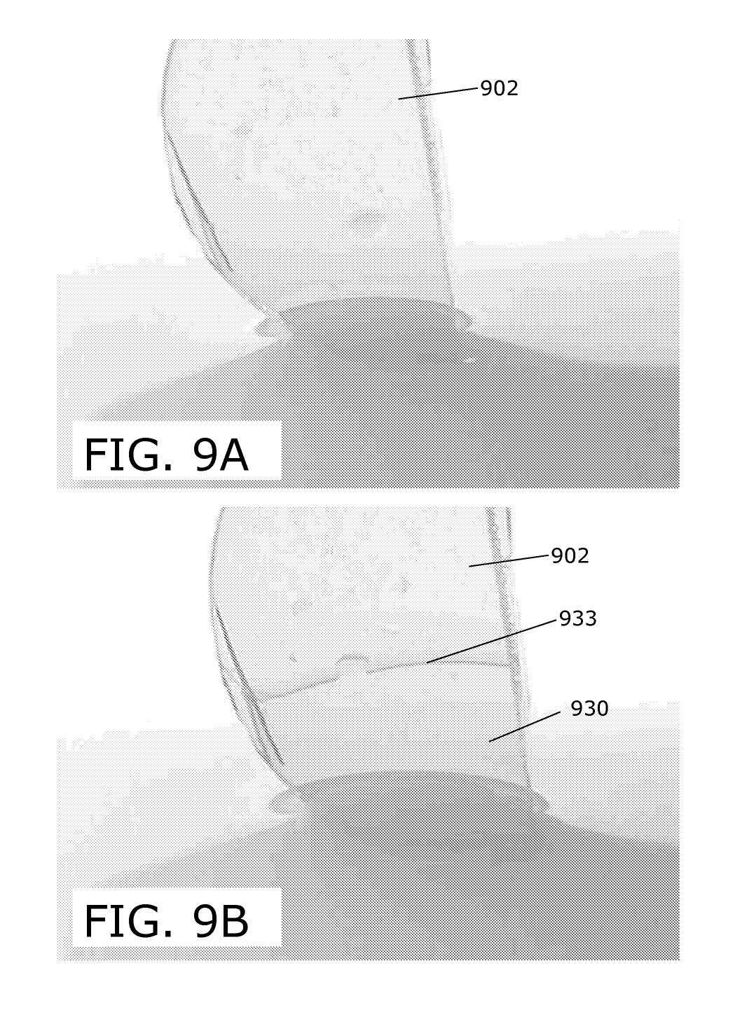

FIGS. 9A-B show another example of the filtering capabilities of a nanoporous polymer 902. FIGS. 9A-B show a hydrophilic polymer inserted into full fat milk at 0 min (FIG. 9A) and after 5 minutes (FIG. 9B). The transparent fluid 930 penetrates into the nanoporous polymer, while the large fat particles, which scatter light, are left out. After 5 minutes (FIG. 9B) the transparent fluid has overcome gravity due to capillary forces, such that an interface 933 between a fluid filled part of the nanoporous polymer and a dry part of the nanoporous polymer is visible above the surface of the milk. Note how the transparent milk fluid is filling the polymer while the fat particles, causing the milk to be opaque, are excluded. After filling some fat is collected on the surface of the submerged part of the sample, but it can be easily wiped off. It is noted that the slight yellowness (which shows up a grey on FIGS. 9A-B) of the nanoporous polymer in FIGS. 9A-B is because they are not treated with the UV thiolene process, but instead simply oxidized under UV excitation (as described in Ndoni2009). The UV thiolene process may be faster, more efficient and more controlled and may leave the polymer sample completely transparent in the visible and near-infrered part of the spectrum.

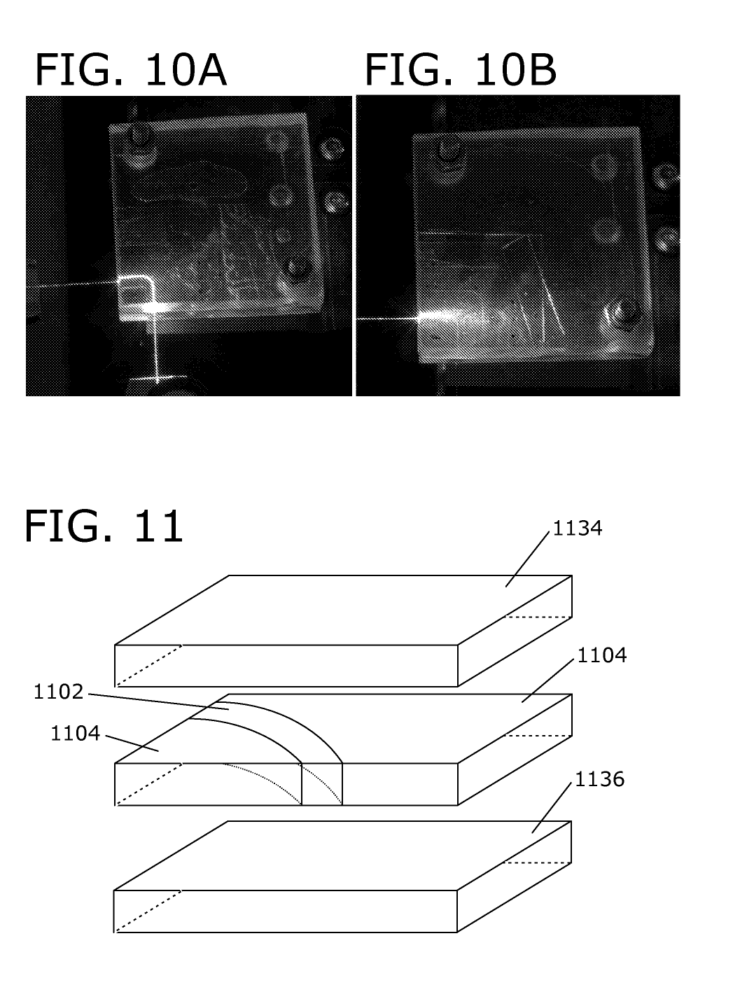

FIG. 10A show the nanoporous polymer, which in an empty (not fluid filled state) has an effective refractive index of 1.26, and which is intrinsically hydrophobic. Hydrophilic groups are bound to the inner surface of the pores by UV activated thiolene chemistry so as to device the first element, which is enclosed by the second element, being the part of the polymer where no hydrophilic groups have been bound. The exposed hydrophilic areas corresponding to the first element, have been filled with an aqueous solution by microcapillary forces, raising the refractive index to 1.42, enabling the fluid filled first element to guide light, which shows up in FIG. 10A as a bright, curved line indicating that light is redirected 90 degrees. The light is light of wavelength 633 nm which is transmitted through the waveguide from the input fiber to the output fiber.

FIG. 10B shows the same setup as in FIG. 10A, however, in FIG. 10B the first element is no longer fluid filled, as it has been left to dry for 30 minutes whereafter the waveguide no longer guides light.

FIG. 11 show an perspective, exploded view of a setup according to an embodiment of the invention, where a the first element 1102 is a part of a planar element (which is constituted by first element 1102 and second element 1104), where the first element extends from the top side to the bottom side of the planar element, and the second element 1104 is another part of the planar element, where the second element is placed on both sides of the first element, and extending from the top side to the bottom side of the planar element, and a third element 1134, 1136 may be placed adjacent to the top and bottom side of the planar element. During measurements, the third element 1134, 1136 are pressed against the first and second element.

To sum up the invention provides a sensor element which comprises a first element which is nanoporous, and a second element which is nanoporous, the second element enclosing the first element. The surfaces of the nanopores of the first- and second element differ in hydrophilicity, so that the surfaces of the nanopores of one element is generally more hydrophobic while the other is generally more hydrophilic, and hence the sensor element is capable of selectively having the first element filled with a fluid. The sensor element is capable of guiding light through the fluid-filled first element and can act as a nanoporous waveguide. The sensor element according to the invention is particularly useful for spectroscopy on fluids.

In one exemplary embodiment, there is provided:

E1. A sensor element comprising
a first element having a first end, adapted to receive light and a second end adapted to output or reflect light, the first element being extended along a direction of propagation, at least part of the first element being nanoporous, and
a second element being nanoporous, the second element enclosing at least a part of the first element along the direction of propagation, and
an access to at least a part of the first element for a fluid, so that the first element may in a situation of use be filled by a fluid, and

wherein surfaces of the nanopores of the first element and the second element differ in hydrophilicity, so that one of the first element and the second element is generally hydrophilic and the other of the first element and the second element is generally hydrophobic.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

Annex 1

TABLE I
WATER CLADDING

| | | | Power, | Power, | |
|---|---|---|---|---|---|
| Waveguide | Length | Ratio | output | input | Loss |
| number | [mm] | (out/in) | [micro W] | [W] | [dB] |
| 1 | 4.712 | 3.75E−01 | 422 | 1.13 | 4.26E+00 |
| 2 | 8.712 | 3.20E−01 | 365 | 1.14 | 4.96E+00 |
| 3 | 12.712 | 1.47E−01 | 166.6 | 1.13 | 8.33E+00 |
| 4 | 16.712 | 6.25E−02 | 71.5 | 1.14 | 1.20E+01 |
| 5 | 20.712 | 3.24E−02 | 36.9 | 1.14 | 1.49E+01 |

TABLE II
FEP CLADDING

| | | | Power, | Power, | |
|---|---|---|---|---|---|
| Waveguide | Length | Ratio | output | input | Loss |
| number | [mm] | (out/in) | [micro W] | [W] | [dB] |
| 1 | 4.712 | 1.09E−01 | 123.9 | 1.13 | 9.61E+00 |
| 2 | 8.712 | 9.04E−02 | 102.3 | 1.14 | 1.04E+01 |
| 3 | 12.712 | 4.27E−02 | 48.4 | 1.13 | 1.37E+01 |
| 4 | 16.712 | 1.36E−02 | 15.5 | 1.14 | 1.87E+01 |
| 5 | 20.712 | 1.24E−02 | 14.1 | 1.14 | 1.91E+01 |

TABLE III
NANOPOROUS CLADDING

| | | | Power, | Power, | |
|---|---|---|---|---|---|
| Waveguide | Length | Ratio | output | input | Loss |
| number | [mm] | (out/in) | [micro W] | [W] | [dB] |
| 1 | 4.712 | 2.54E−01 | 343.8 | 1.35 | 5.95E+00 |
| 2 | 8.712 | 2.32E−01 | 313.9 | 1.35 | 6.35E+00 |
| 3 | 12.712 | 1.34E−01 | 181.6 | 1.35 | 8.72E+00 |
| 4 | 16.712 | 8.66E−02 | 117.3 | 1.35 | 1.06E+01 |
| 5 | 20.712 | 3.30E−02 | 45 | 1.36 | 1.48E+01 |

1. A sensor element comprising:
a first element having a first end, adapted to receive light and a second end adapted to output or reflect light, the first element being extended along a direction of propagation, at least part of the first element being nanoporous,
a second element being nanoporous, the second element being placed adjacent to at least a part of the first element along the direction of propagation, and
an access to at least a part of the first element for a fluid, so that the first element may in a situation of use be filled by a fluid,
wherein surfaces of the nanopores of the first element and the second element differ in hydrophilicity, so that one of the first element and the second element is generally hydrophilic and the other of the first element and the second element is generally hydrophobic, wherein the first element is arranged to be part of a core of an optical waveguide when the nanopores of the first element are filled by the fluid.

2-15. (canceled)

16. The sensor element according to claim 1, wherein the second element encloses only a part of the first element, and a third element is arranged for ensuring that a surrounding media cannot enter a volume adjacent the first element where an evanescent optical field of a guided mode of the first element may be present.

17. The sensor element according to claim 1, wherein the second element encloses only a part of the first element, and the sensor element further comprising a third element, the third element being a solid element placed adjacent to the remaining part of the first element.

18. The sensor element according to claim 1, wherein the second element is enclosing at least a part of the first element along the direction of propagation.

19. The sensor element according to claim 1, wherein the first element is dimensioned so as to form the core of a single mode optical waveguide, when the nanopores are filled with a fluid.

20. The sensor element according to claim 1, wherein the first element and/or second element comprises a polymeric material.

21. The sensor element according to claim 1, wherein the first and/or second element comprises a polymer matrix, which has a porosity of 0.1-90% (v/v) and an initial water absorption (% (w/w)) so that the ratio between said initial water absorption (% (w/w)) and said porosity (% (v/v)) is at the most 0.05, said matrix at least in part capable of being rendered more hydrophilic so that said part of said polymer matrix has a final water absorption (% (w/w)) so that the ratio between said final water absorption (% (w/w)) and said porosity (% (v/v)) is at least 0.05.

22. The sensor element according to claim 1, wherein the bulk material of the first element is similar to the bulk material of the second element.

23. The sensor element according to claim 1, wherein an effective average diameter of nanopores of the first element and/or the second element is similar to or inferior to a wavelength, lambda, of light transmitted through the sensor element.

24. The sensor element according to claim 1, comprising a plurality of first elements.

25. A system comprising a sensor element according to claim 1, further comprising a light source and/or a light detector.

26. A method of spectroscopy on a fluid comprising:
providing a spectroscopy system comprising the sensor element of claim 1;
providing a liquid to said spectroscopy system; and
performing spectroscopy on said liquid.

27. A method of manufacturing a sensor element comprising:
providing a first element with nanopores, and
providing a second element enclosing at least a part of the first element around an axis through the first element, and
modifying the hydrophilicity of the surfaces of the nanopores of the first element and/or the second element, so that the surfaces of the nanopores of the first element and the second element differ in hydrophilicity, so that one of the first element and the second element is generally hydrophilic and the other of the first element and the second element is generally hydrophobic.

28. The method according to claim 27, wherein the modifying of the hydrophilicity of the surfaces of the nanopores of the first element and/or the second element, comprises irradiation with light.

29. The method according to claim 28, wherein the irradiation of the first element with light occurs prior to providing a second element enclosing at least a part of the first element around an axis through the first element.

30. The method according to claim 28, wherein the first element and/or the second element is rotated during irradiation of the first element and/or the second element with light.

31. The method according to claim 28, wherein the irradiation with light comprises a photochemical reaction involving a multi-photon process.
